(19) United States
(12) Patent Application Publication
(10) Pub. No.: US 2021/0045392 A1
(43) Pub. Date: Feb. 18, 2021

(54) BAKED DOUGH PRODUCT HAVING NUMEROUS LAYERS AND METHODS FOR FORMING THE SAME

(71) Applicant: PRAGEL LLC, Brooklyn, NY (US)

(72) Inventor: Andreas Grasshoff, New York, NY (US)

(21) Appl. No.: 16/993,363

(22) Filed: Aug. 14, 2020

Related U.S. Application Data
(60) Provisional application No. 62/887,316, filed on Aug. 15, 2019.

(51) Int. Cl. A21D 8/06; A21D 8/02; A21D 2/02; A21D 13/10

(52) U.S. Cl. CPC A21D 8/06; A21D 13/10; A21D 2/02; A21D 8/02

(57) ABSTRACT

Baked dough products and methods for forming baked dough products are disclosed. The products have an internal structure with numerous layers, which are formed by folding the dough before baking. The numerous layers in the internal structure and other aspects of the products and methods provide for light, airy products that include a combination of appealing aspects found in other types of baked products such as croissants, pretzels, and bagels.

### BACKGROUND

### Field of the Invention

The invention is related to baked dough products and methods for forming such products. In particular, the invention relates to baked dough products and methods for forming baked dough products, characterized by the products having an internal structure with numerous layers.

### Related Art

There are many types of products made by baking flour-based dough. Such products include bagels, croissants, and pretzels, each of which has characteristics that make the products popular. For example, consumers often find the light, buttery texture of croissants appealing. On the other hand, consumers sometimes prefer the less flaky nature of pretzels, particularly the crust of pretzel, to that of croissants. As another example, consumers often utilize the size and shape of bagels to support fillings to create combinations of flavors, such as in a bagel sandwich. New types of baked dough products that can combine the appealing aspects of these and other baked products would be highly desirable.

### SUMMARY OF THE INVENTION

In one aspect, the invention includes a method of creating a product from dough. The method comprising steps of (a) forming a pre-dough consisting of wheat flour and water; (b) forming a dough consisting of the pre-dough, butter, salt, sugar, and water; (c) rolling out the dough; (d) folding the dough multiple times to create about 144 layers in the dough; and (e) baking the dough to form the product.

According to another aspect, the invention includes another method of creating a product from dough. This method includes steps of (a) forming a pre-dough consisting of wheat flour and water; (b) forming a dough consisting of the pre-dough, butter, salt, sugar, and water; (c) rolling out the dough; (d) folding the dough a plurality of times to create about 144 layers in the dough; and (e) baking the dough for 5 minutes or less.

According to yet another aspect, the invention includes a further method of creating a product from dough. This method includes steps of (a) forming a pre-dough consisting of wheat flour and water; (b) forming a dough consisting of the pre-dough, butter, salt, sugar, and water; (c) rolling out the dough; (d) folding the dough multiple times to create about 144 layers in the dough; (e) freezing the dough; (f) dipping the frozen dough in an alkali solution, and (e) baking the frozen dough for about 5 minutes or less to form the product. No yeast is added as an ingredient in steps (a) and (b), and the baked product comprises about 33% butter.

### BRIEF DESCRIPTION OF THE DRAWINGS

FIG. 1 is a view of rolled-out dough for making a product according to an embodiment of the invention.

FIG. 2 is a view of the folded dough according to an embodiment of the invention.

FIG. 3 is a view of the dough shown in FIG. 2 with a further fold.

FIG. 4 is a view of frozen dough for making a product according to an embodiment of the invention.

FIG. 5 is a view of products according to embodiments of the invention.

FIG. 6 is a view showing the internal structure of a product according to an embodiment of the invention.

### DETAILED DESCRIPTION OF THE INVENTION

The invention is related to baked dough products and methods for forming such products. In particular, the invention relates to baked dough products and methods for forming baked dough products, characterized by the products having an internal structure with numerous layers. As will be described in detail below, the inventive products have many outstanding aspects and properties, making them highly desirable.

A process for making products according to embodiments of the invention will first be described. However, before considering the recipes and process steps, it should be noted that terminology for the ingredients, such as butter, salt, and sugar, should be interpreted as those substances are commonly known in the art. And the ingredient terminology should be understood to encompass variations that would fall within the scope of the general terms as they are used in this disclosure.

The process for making the products according to the invention begins by making pre-dough. The pre-dough consists of wheat flour and water. In an example embodiment of the invention, the pre-dough is initially formed by stirring together 50 grams of wheat flour and 50 grams of water. Preferably, the stirring is done at a temperature of about 82° F. (a standard temperature often found in bakeries). The pre-dough is then kneaded to a smooth consistency using, for example, an electric mixer. Optionally, a tiny amount of salt can be added to the mixture at this point to control fermentation. The smooth pre-dough is then allowed to rise by allowing it to stand for an extended period of time (e.g., for about 12 hours), and then refrigerating pre-dough, (e.g., at about 44° F. for about 12 hours).

After the first batch of pre-dough batch has risen, the process of making the pre-dough may be repeated one or more times to build up the amount of pre-dough. For example, another 50 grams of wheat flour and 50 grams of water can be added to the 100 grams of risen pre-dough, with this combined mixture being kneaded and then allowed to rise. In example embodiments of the invention, a total of 2000 grams of pre-dough (1000 grams of wheat flour and 1000 grams of water) is made by iterative additions of flour and water before starting the process of making the dough. Generally speaking, it may take about 5-20 days to create 2000 grams of pre-dough using the example process.

It is important to note that no yeast is added to the pre-dough mixture. Rather, fermentation in the pre-dough is achieved only by naturally occurring yeast from the air. In this regard, the inventive product is similar to many sourdough breads, which are often made through naturally occurring fermentation and have no added yeast.

After the pre-dough is made, the dough is created by combining the pre-dough and other ingredients. The following TABLE 1 shows the ingredients for the dough. Note that the percentages of each ingredient relative to the total amount of flour (by weight) in the dough. For example, the amount of water is 37.5% of the total amount of flour, so if there is a total of 2000 grams of flour when the dough is being formed, then 750 grams of water should be added. Also note that the total amount of flour from which the percentages of the ingredients are derived includes both the wheat flour that is added as an ingredient and the wheat flour that is in the pre-dough ingredient.

TABLE 1

| | Percentage Relative to |
|---|---|
| Ingredient | Total Amount of Flour |
| Wheat Flour | 87.5% |
| Pre-Dough | 25% |
| Butter | 8% |
| Salt | 2.2% |
| Sugar | 7% |
| Water | 37.5% |

As indicated in the table, the dough consists of only five substances: wheat flour, butter, salt, sugar, and water. This makes the recipe simple compared to recipes for other types of dough products, as the ingredients are reduced to the essentials. Also, it should be noted that as with the pre-dough, no yeast is added to the dough.

All of the ingredients are mixed to form the dough. The dough is then kneaded fully and stretched until it is thin, and then chilled (e.g., for 15 minutes about a temperature of about 35-41° F.). Note, by using the recipe indicated above, the dough contains about 13% to 15% proteins, which provides for maximum elasticity, allowing it to be thinly stretched.

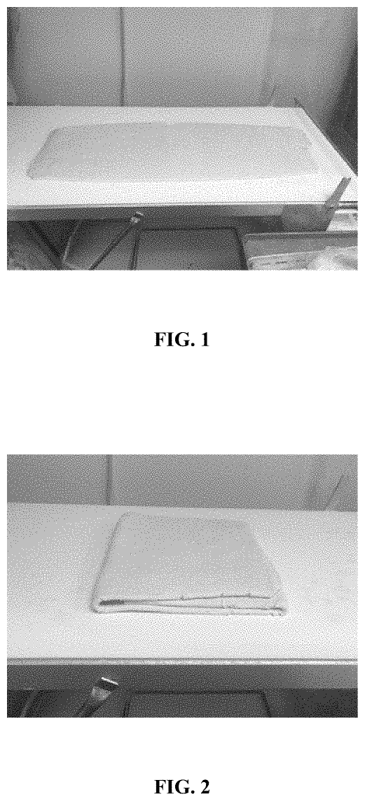

Next, the dough is rolled out flat on a board, as shown in FIG. 1. The dough can then be folded to create layers. Such a folding process is also referred to as a dough lamination process in the art. Before beginning the folding process, a block of butter is placed on top of the dough. In embodiments of the invention, the block of butter is big enough to cover about 50% of the surface of the rolled out dough. Further, the block of butter is sized such that 300 grams of butter is added per 1000 grams of dough.

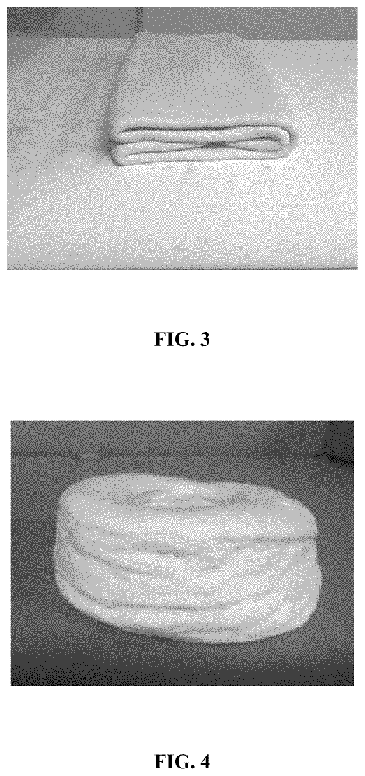

FIGS. 2 and 3 show examples of two steps of a folding process according to embodiments of the invention. As will be recognized by those skilled in the art, FIG. 2 shows a simple book fold, which results in the dough being folded three times. FIG. 3 shows the folded dough from FIG. 2 after being further folded using a double book fold, with the dough being folded four more times as a result of the double book fold. Together, the combination of the simple book fold and the double book fold creates 12 layers (3 folds×4 folds) in the dough.

After the simple and double book folds, the dough is chilled again (e.g., for 30 minutes in the refrigerator at about 35-45° F.). The dough is then ready for more folding. In further embodiments, for example, the dough is again folded with a combination of simple and double book folds, after which the dough will have 144 layers (3 folds×4 folds×3 folds×4 folds). And, as a result of the placement of the butter block at the outset of folding, butter is now spaced over the layers. As will be appreciated by those skilled in the art, folding dough to create numerous (e.g., 144) layers is not done in processes of making most, if any, prior-art products. For example, croissants are often formed with layers by folding of the dough. However, croissant dough is usually only folded to the point that the products have about 27-48 layers. This is likely because more than about 48 layers cannot be seen in the croissants. Moreover, there has not been any other recognized benefit in providing croissant-type products with more than 27-48 layers. However, as will be discussed in more detail below, it has been found that the numerous layers in products according to embodiments of the invention provide excellent taste and other beneficial qualities.

As will also be appreciated in light of the full disclosure herein, it is not required that the dough necessarily be folded to result in exactly 144 layers. Rather, the dough should be folded have about 144 layers in order to achieve the beneficial properties of the products described herein.

After folding of the dough is complete, the dough is ready to be rolled out to and cut into the desire product shapes. A dough sheeter machine can be used, and rolled out dough can then be cut into any desired shape. Examples of designs include bagel shapes, stars, hearts, pretzel-shapes, etc.

The shaped and cut dough is next allowed to rise, for example, in an environment with a temperature of about 82° F. An aspect of the invention is to allow the dough to rise at this point to a volume that is about 66% of its maximum potential volume that the dough could achieve. It has been found that by being close, but not at the maximum potential volume, the baked dough products will have the best balance of taste and airiness.

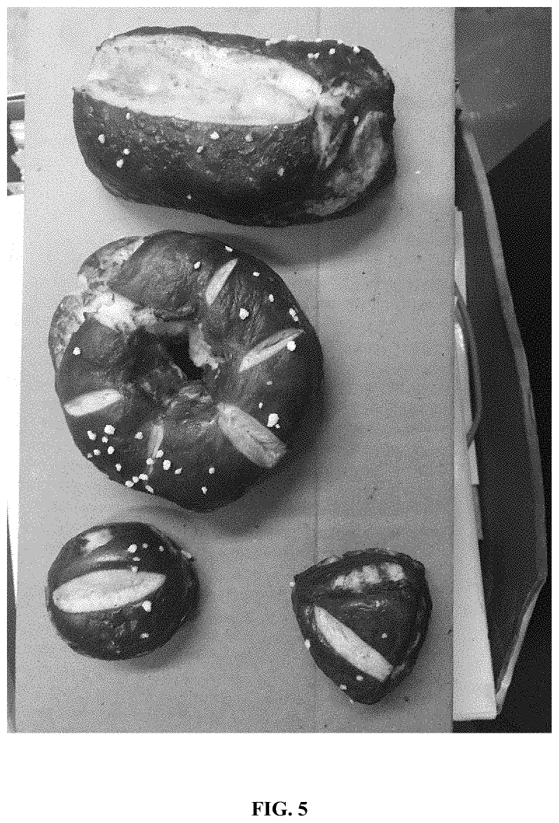

If desired, the risen dough may be immediately baked into the final products. However, other aspects of the invention provide for the dough to be frozen for a period of time before baking. In embodiments of the invention, the dough may be chilled (e.g., to −4° F.) until it is frozen solid. FIG. 4 shows an example of a frozen dough product according to an embodiment of the invention. The ability to freeze the dough greatly enhances the utility of the invention by enabling the products to be quickly made on demand. In this regard, the structure of the dough with numerous layers facilitates the frozen dough being quickly baked to the final product, as will be discussed below.

The freezing of the dough also provides for another aspect of the invention. Before baking, the frozen dough can be dipped in an alkali solution such as lye (i.e., sodium hydroxide, NaOH). In specific embodiments of the invention, the frozen dough is dipped in a 2.75% liquid lye solution for about one second such that the frozen dough is completely covered with the solution. As will be appreciated by those skilled in the art, the lye will cause a reaction on the surface of the dough, and as a result, the baked products will have a thin, brown, pretzel-like crust. Moreover, the crust will not be flaky. It should also be noted that the dipping the dough in a frozen state greatly facilitates the application of the lye coating to the surface of the dough. That is, the lye sticks more thickly on the dough. Further, in many embodiments of the invention, the frozen dough is not immediately baked after the lye dipping, but rather may be stored for later baking. In such cases the lye helps to stabilize the frozen dough. Thus, the combination of frozen dough and lye application to the frozen dough provides multiple benefits.

When desired, the frozen dough may be baked into the final products. An aspect of the invention is that the frozen dough can be baked quickly. In this regard, the dough does not need to be thawed before baking, but rather can go directly in the oven in the frozen state. For example, using an oven at a temperature of about 400° F., the frozen dough can be baked into the final product in about 5 minutes or less. The short baking time stems from the light and thin structure resulting from the numerous layers in the already risen dough. Moreover, the light, thin, airy structure found in the baked dough (described more fully below) allows for quick cooling of the baked product. To facilitate commercial production, the oven may be conveyor belt type oven, such as those made by TurboChef of Carrollton, Tex.

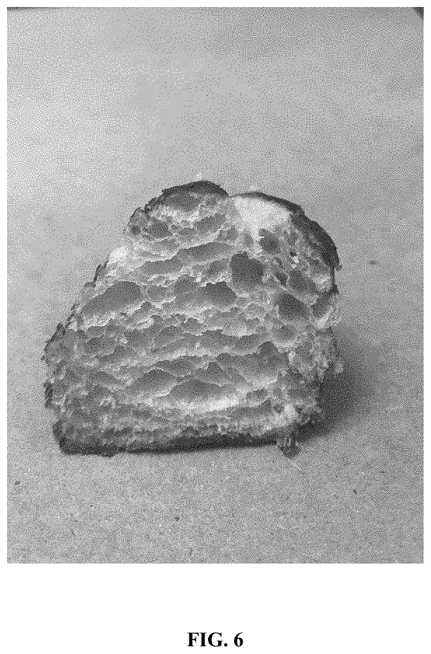

FIGS. 5 and 6 are photographs of products according to embodiments of the invention. As is readily apparent from the photograph in FIG. 5, the outsides of the products resemble pretzels with a brownish crust. As noted above, this crust is not flaky, and thus will sometimes be more desirable than flaky-crust products such as croissants. Note that salt has been added to the crust of the products in FIG. 5, which further emphasizes similarity to a pretzel. The product in FIG. 6 has been cut, and the picture is magnified so that the internal structure of the product can be easily seen. The internal structure is light and airy, and is less dense than, for example, a bagel. This again is a result of the numerous layers that were formed in the dough used to make the product. At the same time, the product has more internal structure than an ordinary croissant, and, thus, the inventive product is much less likely to suffer from internal collapsing, as sometimes happens with croissants.

TABLE 2 below shows a comparison of properties of a product according to the invention, an ordinary croissant, and an ordinary bagel. The volumes of the croissant, bagel, and inventive product were measured by determining the amount of rice displaced by the croissant, bagel, and product on a scale. Specifically, rice was weighted on a scale, the scale was tared (zeroed), the croissant, bagel, or inventive product was added to the rice, the rice was removed till the scale weight returned to zero, and the volume of the removed rice was measured to correspond to the volume of the croissant, bagel, or inventive product.

TABLE 2

| | Inventive Product | Croissant | Bagel |
|---|---|---|---|
| Weight (g) | 51 | 64 | 177 |
| Volume (ml) | 168 | 182 | 379 |
| Specific Weight (g/L) | 303 | 351 | 476 |

The data in TABLE 2 shows that the inventive product is remarkably lighter than a croissant and bagel. That is, based on the specific weights, the inventive product is about 14% lighter than a croissant and about 36% lighter than a bagel. This difference is primarily a result of the numerous layers in the structure of the inventive product. It should also be noted that the inventive product is about 33% butter relative to the total weight of the product. If there was this much butter but fewer layers, the specific volume for the product would be much greater and the dough would not rise to the extent of that it does in the inventive products.

In sum, products according to the invention have a unique combination of properties. The products have a light, layered structure similar to a buttery croissant, can have the shape of traditional bagel, and can have a salty crust similar to pretzel. The tasting experience of the products is exceptional.

Besides the taste, there are other outstanding aspects of the inventive products. For example, as discussed above, no yeast is added in the process of making the dough. Thus, the product can be consumed by individuals allergic to yeast. Moreover, the airy, layered structure of the products makes the products easier to digest than more dense dough products, such as bagels. And the layered structure makes the products much easier to cut than bagels as well. This in turn makes it easier to add fillings to the products. Still further, the inventive products have a salty nature that works well with both sweet and savory fillings.

The inventive process of making the products leads to numerous benefits for in terms of commercial applications. The ability to freeze the dough allows the products to be distributed to different locations for baking at a later time. And at the baking location, the products can be quickly baked while still in a frozen state. Thus, a seller can quickly provide fresh products without any specialized knowledge or equipment for making the dough for the products.

What's more, the production process is extremely efficient. As noted above, the ingredients are reduced to the essentials. The waste can also be reduced to a minimum. For example, leftover dough can be used in the next batch of dough because the dough never has more than the 8% butter of the recipe. This is very advantageous in comparison to similarly produced folded (laminated) products.

Although this invention has been described in certain specific exemplary embodiments, many additional modifications and variations would be apparent to those skilled in the art in light of this disclosure. It is therefore to be understood that this invention may be practiced otherwise than as specifically described. Thus, the exemplary embodiments of the invention should be considered in all respects to be illustrative and not restrictive, and the scope of our invention to be determined by any claims supportable by this application and the equivalents thereof, rather than by the foregoing description.

### INDUSTRIAL APPLICABILITY

As noted herein, the inventive products and inventive processes for making the products are applicable in the commercial production of baked goods.

1. A method of creating a product from dough, the method comprising steps of:
(a) forming a pre-dough consisting of wheat flour and water;
(b) forming a dough consisting of the pre-dough, butter, salt, sugar, and water;
(c) rolling out the dough;
(d) folding the dough multiple times to create about 144 layers in the dough; and
(e) baking the dough to form the product.

2. A method of claim 1, wherein the folding step (d) includes:
a first folding of the dough using a single book fold to create 3 layers in the dough;
a second folding of the dough using a double book fold to create 12 layers in the dough;
a third folding of the dough using another single book fold to create 36 layers in the dough; and
a fourth folding of the dough using another double book fold to create 144 layers in the dough.

3. A method according to claim 1, wherein the dough is baked for about 5 minutes or less at a temperature of about 400° F.

4. A method according to claim 1, wherein the dough is frozen after having been folded in step (d) and before being baked in step (e).

5. A method according to claim 4, wherein the dough is baked in step (e) in a frozen state without being thawed.

6. A method according to claim 4, further comprising a step of dipping the frozen dough in an alkali solution before the dough is baked in step (e).

7. A method according to claim 1, wherein, after completion of baking in step (e), the product comprises about 33% butter.

8. A method according to claim 1, wherein the pre-dough is formed by repeating steps of:
(a-i) combining wheat flour and water;
(a-ii) allowing the combined wheat flour and water to rise;
(a-iii) adding further wheat flour and water to make additional pre-dough; and
(a-iv) allowing the additional pre-dough to rise.

9. A method according to claim 1, wherein a portion of the pre-dough used in step (b) is made in a separate process that includes steps (a) and (b).

10. A method according to claim 1, wherein a portion of the dough is dough made in a separate process that includes steps (a), (b), (c), and (d).

11. A method of creating a product from dough, the method comprising steps of:
(a) forming a pre-dough consisting of wheat flour and water;
(b) forming a dough consisting of the pre-dough, butter, salt, sugar, and water;
(c) rolling out the dough;
(d) folding the dough a plurality of times to create about 144 layers in the dough; and
(e) baking the dough for about 5 minutes or less to form the product.

12. A method according to claim 11, wherein the dough is baked at a temperature of about 400° F.

13. A method of claim 11, wherein the folding step (d) includes:
a first folding of the dough using a single book fold to create 3 layers in the dough;
a second folding of the dough using a double book fold to create 12 layers in the dough;
a third folding of the dough using another single book fold to create 36 layers in the dough; and
a fourth folding of the dough using another double book fold to create 144 layers in the dough.

14. A method according to claim 11, wherein the dough is frozen after having been folded in step (d) and before being baked in step (e).

15. A method according to claim 14, wherein the dough is baked in step (e) in a frozen state without being thawed.

16. A method according to claim 14, further comprising a step of dipping the frozen dough in an alkali solution before the dough is baked in step (e).

17. A method according to claim 11, wherein, after completion of baking in step (e), the product comprises about 33% butter.

18. A method of creating a product from dough, the method comprising steps of:
(a) forming a pre-dough consisting of wheat flour and water;
(b) forming a dough consisting of the pre-dough, butter, salt, sugar, and water;
(c) rolling out the dough;
(d) folding the dough multiple times to create about 144 layers in the dough;
(e) freezing the dough;
(f) dipping the frozen dough in an alkali solution, and
(e) baking the frozen dough for about 5 minutes or less to form the product, wherein no yeast is added as an ingredient in steps (a) and (b), and wherein the baked product comprises about 33% butter.
